(19) United States
(12) Patent Application Publication
(10) Pub. No.: US 2008/0165130 A1
(43) Pub. Date: Jul. 10, 2008

(54) Wireless Mouse

(75) Inventor: Tsung-Min Chen, Sijhih City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BEHAVIOR TECH COMPUTER CORP., Sijhih City (TW)

(21) Appl. No.: 11/971,595

(22) Filed: Jan. 9, 2008

(30) Foreign Application Priority Data
Jan. 10, 2007 (TW) 96200499

(51) Int. Cl. G06F 3/033

(52) U.S. Cl. 345/163

(57) ABSTRACT

A wireless mouse with a power-saving display is disclosed. The wireless mouse has a power-detection module disposed therein to detect a power status of a power supply module inside the wireless mouse. Then, the wireless mouse can learn the power status of the power supply module and display the power status on an e-paper display module disposed in the wireless mouse. As a result, the user of the wireless mouse may be informed of the status of the wireless mouse in real time based on a messages displayed on the e-paper display module.

This application claims the benefit of priority based on Taiwan Patent Application No. 096200499 filed on Jan. 10, 2007, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention relates to a mouse. More specifically, the present invention relates to a wireless mouse that displays functional messages on an electronic-paper (e-paper).

2. Descriptions of the Related Art

The wireless mouse is one of the most commonly used peripheral devices by computer users. Due to the wireless nature of the mouse, it is more convenient to use. On the other hand, since the wired transmission is eliminated, the mouse can not obtain power directly supplied by the associated host computer. Consequently, a built-in battery is needed in the wireless mouse to supply power. However, since it is difficult for the user to know the power status of the battery just from the appearance of the wireless mouse, it is usually only until the battery is exhausted that the user is aware of the battery status.

To avoid the inconvenience caused by the unpredicted power loss of the wireless mouse, Taiwan Patent No. M259239, titled “power supply alerting device for a wireless mouse,” has disclosed a low voltage detection circuit that is used to detect the power status of the built-in battery of a wireless mouse. Once the low power of the battery is detected, an alerting sound will be sounded by the audio device in the wireless mouse to alert the user to the status.

Nevertheless, even with the technical solutions disclosed in Taiwan Patent No. M259239 described above, the user is still unaware of the latest power status of the built-in battery of the wireless mouse in real time. The user knows the power status only when the power is too low. Moreover, this patent uses an alerting sound to alert the user to the low power status of the wireless mouse, which may be unperceivable to those suffering a hearing impairment. Furthermore, if the alerting sound is excessively high, it increases the power consumption of the built-in battery of the wireless mouse, which is not in accordance with the power saving requirement of the wireless mouse.

In contrast to the alerting sound used by the low power alert in Taiwan Patent No. M259239 described above, other conventional wireless mice display the information relating to the wireless mice on a display device. However, since such a display device is typically a liquid crystal display (LCD) or a light-emitting diode (LED) which requires a continuous power supply to maintain the normal display of the information, this will inevitably add to more power consumption in the battery of the wireless mouse.

Therefore, a solution is urgently needed in the wireless mouse industry to display information on the display device of a wireless mouse without increasing the power consumption of the wireless mouse.

### SUMMARY OF THE INVENTION

One objective of the present invention is to provide a wireless mouse with a display, which displays a related current status of the wireless mouse on an electronic paper (e-paper), so that a user may immediately know the operating status by the information displayed. The e-paper used here meets the power-saving requirement of the wireless mouse.

To this end, according to one embodiment of the present invention, a wireless mouse with a power-saving display is provided The wireless mouse comprises an input operation interface, a displacement-detection module, a power supply module, a power-detection module, a wireless transmission module, an electronic-paper (e-paper) display module and a control module. The input operation interface is configured to generate an operation signal in response to a user's operation. The displacement-detection module is configured to generate a detection signal in response to a displacement of the wireless mouse. The power supply module is configured to supply a power required by the wireless mouse. The power-detection module is configured to detect a power status of the power supply module. The wireless transmission module is configured to receive or transmit signals from the control module and to transmit the signals wirelessly. The control module is electrically connected to the input operation interface, the displacement-detection module, the power supply module, the power-detection module, the wireless transmission module, and the e-paper display module to control operations of the wireless mouse and to transmit the operation signal generated by the input operation interface and the detection signal generated by the displacement-detection module to the wireless transmission module. Additionally, the control module is configured to display the power status of the power supply module on the e-paper display module according to the detection performed by the power-detection module.

According to another embodiment of the present invention, a wireless mouse with a power-saving display is provided. The wireless mouse comprises an input operation interface, a displacement-detection module, a rechargeable battery, a charging module, a charge-detection module, a power-detection module, a wireless transmission module, an e-paper display module, and a control module. The input operation interface is configured to generate an operation signal in response to a user's operation. The displacement-detection module is configured to generate a detection signal in response to a displacement of the wireless mouse. The rechargeable battery is configured to supply a power required by the wireless mouse. The charging module is configured to charge the rechargeable battery. The charge-detection module is configured to determine a charging status of the charging module. The power-detection module is configured to detect a power status of the rechargeable battery. The wireless transmission module is electrically connected to the control module and to receive/transmit signals of the control module through a wireless transmission. The control module is electrically connected to the input operation interface, the displacement-detection module, the rechargeable battery, the charge detection module, the power-detection module, the wireless transmission module, and the e-paper display module to control the wireless mouse. The control module is primarily configured to control the operation of the wireless mouse and to transmit the operation signal and the detection signal to the wireless transmission module. Additionally, the control module is configured to display the charging status on the e-paper display module according to the determination performed by the charge-detection module and the detection performed by the power-detection module.

According to still another embodiment of the present invention, a wireless mouse with a power-saving display is provided. The wireless mouse comprises an input operation interface for generating an operation signal in response to a user's operation; a displacement-detection module for generating a detection signal in response to a displacement of the wireless mouse; a wireless transmission module for transmitting a wireless signal; an e-paper display module; and a control module. The control module is electrically connected to the input operation interface, the displacement-detection module, the wireless transmission module, and the e-paper display module to control the operation of the wireless mouse, and to display a display message on the e-paper display module.

An e-paper display module is used as the display device in the wireless mouse of the present invention so that the control module may display the related display message on the e-paper display module. In this way, the wireless mouse may be provided with a power-saving display function.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram of the first embodiment of the present invention;

FIG. 2 is a schematic profile view of the first embodiment of the present invention;

FIG. 3 is a flow chart of the first embodiment of the present invention;

FIG. 4 is a block diagram of the second embodiment of the present invention;

FIG. 5 is a flow chart of the second embodiment of the present invention; and

FIG. 6 is a block diagram of the third embodiment of the present invention.

### DESCRIPTION OF THE PREFERRED EMBODIMENT

The wireless mouse of the present invention uses an electronic paper (e-paper) as the display module. Since the e-paper does not consume any power as long as the display information remains unchanged, power will be consumed until the display information is changed. Therefore, the e-paper possesses a superior power-saving property. In view of this, the wireless mouse of the present invention uses the power-saving e-paper to display a display message to provide convenience for the user and mitigate the power consumption caused by the message display.

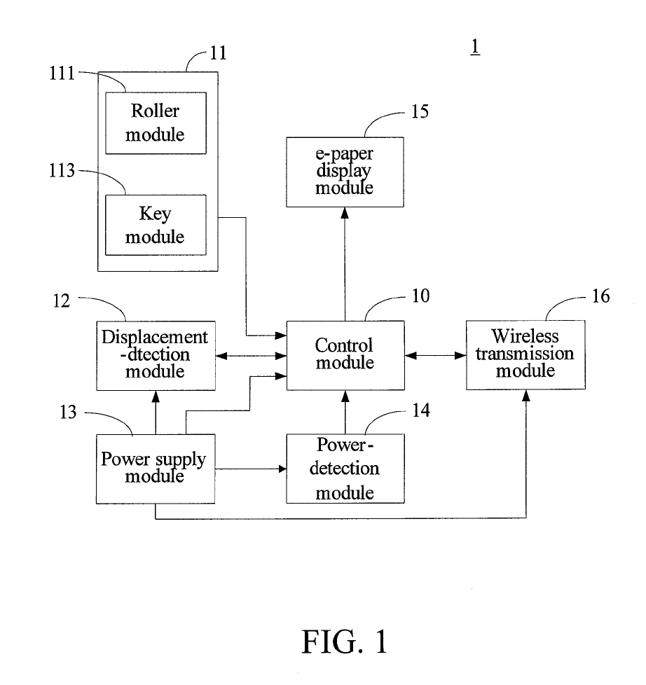

As shown in FIG. 1, a block diagram of a first embodiment of the present invention is illustrated. The wireless mouse 1 comprises a control module 10, an input operation interface 11, a displacement-detection module 12, a power supply module 13, a power-detection module 14, an electronic-paper (e-paper) display module 15, and a wireless transmission module 16.

The input operation interface 11 further comprises a roller module 111 and a key module 113. The input operation interface 11 is configured to generate an operation signal in response to a user's operation, and the operation signal is outputted to the control module 10. The displacement-detection module 12 is a roller-detection module. It means that the displacement-detection module 12 uses the roller module 111 to detect a displacement of the wireless mouse and to generate a displacement detection signal in response to the displacement of the wireless mouse. In other embodiments, the displacement-detection module 12 may be an optical detection module, which uses an optical module to detect the displacement. The power supply module 13 is configured to supply a power required by the wireless mouse. Specifically, the power supply module 13 may be one of a built-in rechargeable battery, an external rechargeable battery, and an external battery. The power detection module 14 is configured to detect a power status of the power supply module 13. The wireless transmission module 16 may be electrically connected to the control module 10, and is configured to receive a signal from the control module 10 and to transmit the signal wirelessly.

The control module 10 is the control kernel of the wireless mouse and is electrically connected to the input operation interface 11, the displacement-detection module 12, the power supply module 13, the power-detection module 14, the e-paper display module 15, and the wireless transmission module 16 respectively. Apart from receiving the operation signal and the displacement detection signal and outputting the received signals through the wireless transmission module 16, the control module 10 may further display the power status of the power supply module 13 on the e-paper display module 15. The control module 10 learns the power status of the power supply module 13 from the detection outcome of the power-detection module 14. After that, the control module 10 enables the e-paper display module 15 to display the power status in one of a text mode, a graphics mode, and the combination thereof.

On the other hand, in the present invention, the e-paper display module 15 is used to display the power status of the power supply module 13. To avoid an increased power consumption of the wireless mouse 1 due to the frequent change of information displayed by the e-paper display module 15, some thresholds, e.g. 90%, 80%, 70%, . . . , 10% of the full power capacity of the power supply module 12 are preset in the control module 10. Only when the power of the power supply module 13 drops to these thresholds, the control module 10 drives the e-paper display module 15 to display the power status of the power supply module 13.

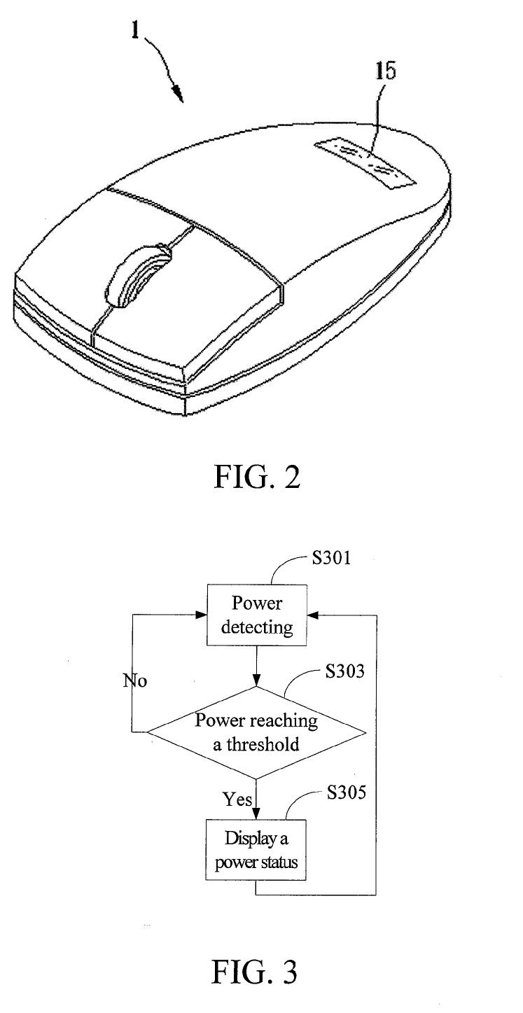

The e-paper display module 15 of the present invention is generally disposed on the surface of the wireless mouse 1. For example, in FIG. 2, the e-paper display module 15 is disposed on the upper surface of the wireless mouse 1, so that the user can see the power status, such as the remaining power, of the wireless mouse 1 directly from the e-paper display module 15.

FIG. 3 illustrates a flow chart of the first embodiment of the present invention, an associated system architecture of which is illustrated in FIG. 1. The flow chart illustrated in FIG. 3 comprises the following steps: the power status of the power supply module 13 is detected by the control module 10 through the power-detection module 14 (S301); the power is determined whether reaching the threshold value (S303), and for this purpose, multiple sets of threshold values may be preset in the control module 10. If the answer of step S303 is yes, the control module 10 drives the e-paper display module 15 to display the current power status of the power supply module (S305), and then the process returns to step S301. If the answer of step S303 is no, the process returns directly to step S301 without displaying the power status.

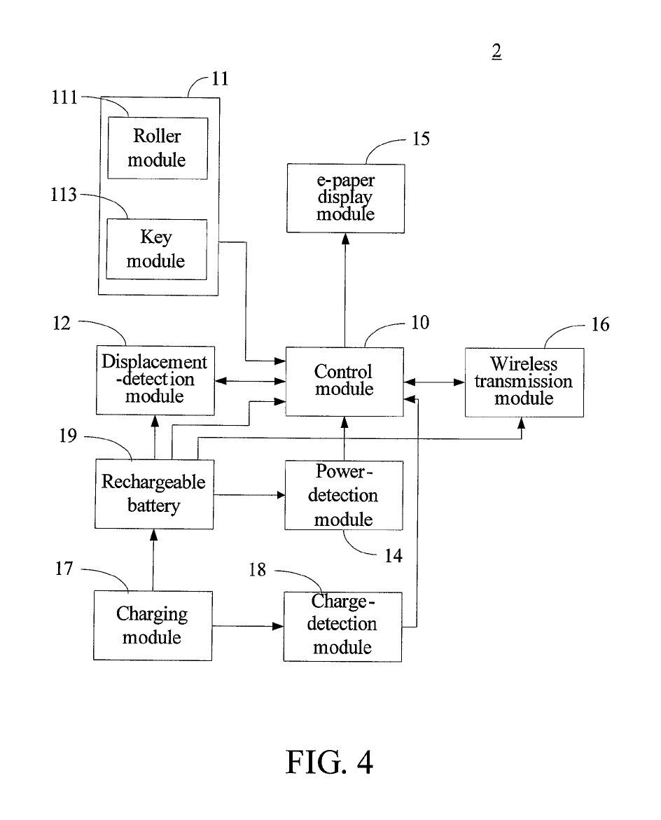

As shown in FIG. 4, a block diagram of a second embodiment of the present invention is illustrated. In the aforesaid first embodiment of the present invention, the remaining power of the power supply module 13 is displayed. In contrast, the wireless mouse 2 shown in FIG. 4 may display a charging status. Compared to the wireless mouse 1 shown in FIG. 1, the charging module 17 and charge-detection module 18 are added in the wireless mouse 2 as shown in FIG. 4. Furthermore, the power supply module 13 shown in FIG. 1 is replaced by a rechargeable battery 19 as shown in FIG. 4.

In FIG. 4, the charge-detection module 18 of the wireless mouse 2 is configured to detect whether the charging module 17 is charging the rechargeable battery 19. For example, when the charging module 17 is feeding a charging voltage to the rechargeable battery 19, the charge-detection module 18 determines that the rechargeable battery 19 is being recharged. Therefore, when the charging module 17 proceeds to charge the rechargeable battery 19, the charge-detection module 18 will inform the control module 10 that the rechargeable battery 19 is being recharged. Thus, the control module 10 is notified of the charging status of the rechargeable battery 19 through the power-detection module 14 and will display such a status on the e-paper display module 15 in one of a text and graphic mode.

The charging module 17 shown in FIG. 4 may be an external charging socket. The charging module 17 (i.e. the external charging socket) comprises an additional e-paper display module to display one of the power status of the power supply module, the charging status, and the combination thereof. The wireless mouse 2 may be plugged into the external charging socket, so that the charging terminals of the rechargeable battery 19 within the wireless mouse 2 may be electrically engaged with the external charging socket for charging the battery.

Alternatively, the charging module 17 may also be a built-in charging circuit directly disposed inside the wireless mouse 2, which directly charges the rechargeable battery 19 from an external power supply. Since only the external transmission line (not shown) is needed to connect with the charging power supply, the wireless mouse 2 may still continue to operate normally during the charging process.

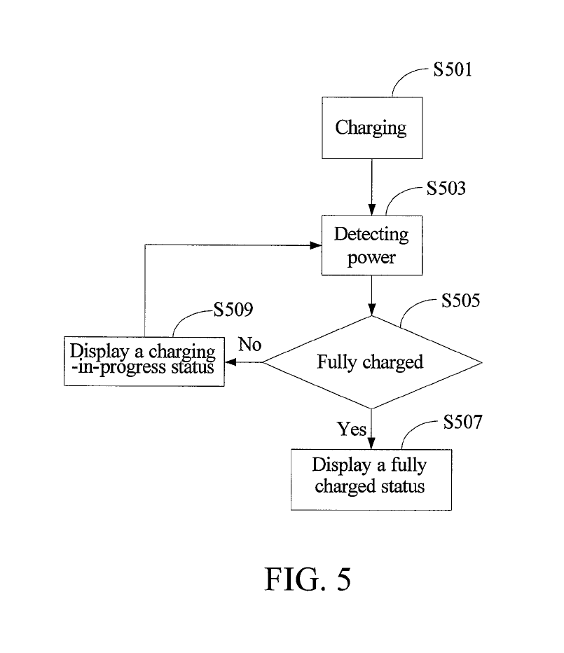

FIG. 5 illustrates a flow chart of the second embodiment of the present invention, an associated system architecture of which is illustrated in FIG. 4. The flow chart illustrated in FIG. 5 comprises the following steps. Initially, when the charging module 17 is charging the rechargeable battery 19 (S501), the control module 10 obtains a message, that the rechargeable battery 19 is being charged, from the charge-detection module 18. Then, the control module 10 detects the power status of the rechargeable battery 19 through the power-detection module 14 (S503). Subsequently, in response to the detection result, the control module 10 determines whether the rechargeable battery 19 has been fully charged (S505). If so, the control module 10 drives the e-paper display module 15 to display a message that the rechargeable battery 19 has been fully charged (S507). If not, the control module 10 drives the e-paper display module 15 to display a message that the rechargeable battery is still charging (S509), and the process returns to step S503.

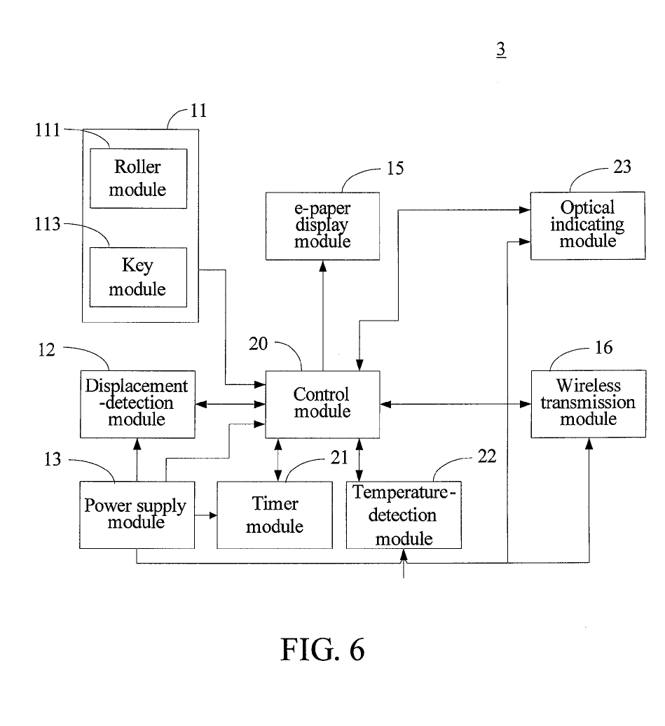

FIG. 6 illustrates a block diagram of a third embodiment of the present invention. The wireless mouse 3 of this embodiment may operate in a mouse mode or a presentation mode, which is determined by the control module 20 according to the operation signal input by the input operation interface 11, for example, the switching signal. When the wireless mouse 3 operates in the presentation mode, the control module 20 may control an optical indication module 23 electrically connected therewith to output an optical signal for the presentation and its functions, such as paging up or paging down, through the input operation interface 11. The detailed operations and functions of the mouse mode and the presentation mode are implemented by the conventional techniques, and will not be described herein.

In FIG. 6, the control module 20 is electrically connected to a timer module 21 and a temperature detection module 22. The timer module 21 may provide a related temporal message, such as to a timer value, a count-down timer value, and a time display,to the control module 20. The temperature detection module 22 may detect a temperature change of the surroundings and output a temperature message to the control module 20. As a result, the control module 20 may further received the message provided by the timer module 21 or the temperature detection module 22 as a display message displayed on the e-paper display module 15. Hence, the wireless mouse 3 of this embodiment may display a temporal message or a temperature message on the e-paper display module 15. When the wireless mouse 3 is operating in the presentation mode, the temporal message may further be used as the elapsed time or remaining time of the presentation.

In the above embodiments, the wireless mice display messages related to the power status, temporal message, or temperature message on the e-paper display module. However, the e-paper display module 15 may also be used to display other messages. For example, for a control module 10 that can obtain the resolution information of the mouse, the mouse resolution may be displayed on the e-paper display module 15. Alternatively, the control module 10 may receive related display messages wirelessly from a computer (not shown) through the wireless transmission module 16, e.g., an email message, a medium playing message (e.g., volume, playing speed, or playing progress), a gadget operating message, a temporal message, or the like from the computer. The gadget operating message provided by the computer may be WIDGET, MSN, SKYPE, GOODTALK, YAHOO, MESSENGER or other related display messages. Additionally, the aforesaid display messages provided by the computer are only of an illustrative nature, but do not intend to limit the present invention. Rather, any messages that may be outputted by the computer to the e-paper display module 15 for display all fall within the spirit and scope of the present invention. Similarly, any messages that can be obtained by the wireless mouse per se for display on the e-paper display module all fall within the spirit and scope of the present invention.

Therefore, in addition to the messages provided by the wireless mouse, the e-paper display module 15 of the present invention may also display related messages obtained externally from the computer. For example, the driver may be installed in the computer to collect related display messages and transmit them to the e-paper display module 15 of the wireless mouse for display. In this way, the wireless mouse of the present invention may provide a slideshow display function.

In conclusion, the wireless mouse with a power-saving display of the present invention has the following features.

1. The wireless mouse can display messages so that a user operating the wireless mouse may be informed of the latest message in real time.

2. The display element used in the wireless mouse is an e-paper display module, which may not only decrease the power consumption of the wireless mouse, but also provide a satisfactory display effect.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless mouse, comprising:
an input operation interface for generating an operation signal;
a displacement-detection module for generating a displacement detection signal in response to a displacement of the wireless mouse;
a power supply module for supplying a power required by the wireless mouse;
a power-detection module for detecting a power status of the power supply module;
a wireless transmission module for transmitting a wireless signal;
an electronic-paper (e-paper) display module; and
a control module, electronically connected with the input operation interface, the displacement-detection module, the power supply module, the power-detection module, the wireless transmission module, and the e-paper display module respectively, for controlling the wireless mouse;
wherein the control module is configured to display the power status of the power supply module on the e-paper display module.

2. The wireless mouse as claimed in claim 1, wherein the input operation interface comprises a roller module and a key module.

3. The wireless mouse as claimed in claim 1, wherein the displacement-detection module is one of an optical detection module and a roller-detection module.

4. The wireless mouse as claimed in claim 1, wherein the power supply module is one of a built-in rechargeable battery, an external rechargeable battery, and an external battery.

5. The wireless mouse as claimed in claim 1, wherein the e-paper display module displays the power status of the power supply module in one of a text mode, a graphic mode, and a combination thereof.

6. A wireless mouse, comprising:
an input operation interface for generating an operation signal;
a displacement-detection module for generating a displacement detection signal in response to a displacement of the wireless mouse;
a rechargeable battery for supplying a power required by the wireless mouse;
a charging module for charging the rechargeable battery;
a charge-detection module for determining a charging status of the charging module;
a power-detection module for detecting a power status of the rechargeable battery;
a wireless transmission module for wirelessly transmitting a signal;
an e-paper display module; and
a control module, electronically connected with the input operation interface, the displacement-detection module, the rechargeable battery, the charge detection module, the power-detection module, the wireless transmission module, and the e-paper display module respectively, for controlling the wireless mouse;
wherein the control module is configured to display one of the charging status, power status, and a combination thereof on the e-paper display module.

7. The wireless mouse as claimed in claim 6, wherein the input operation interface comprises a roller module and a key module.

8. The wireless mouse as claimed in claim 6, wherein the displacement-detection module is one of an optical detection module and a roller-detection module.

9. The wireless mouse as claimed in claim 6, wherein the charging module is one of an external charging socket and a built-in charging circuit.

10. The wireless mouse as claimed in claim 9, wherein the charging module comprises a e-paper display module to display one of the charging status, the power status, and the combination thereof.

11. The wireless mouse as claimed in claim 6, wherein the e-paper display module is configured to display the charging status of the rechargeable battery in one of a text mode, a graphic mode, and a combination thereof.

12. A wireless mouse, comprising:
an input operation interface for generating an operation signal;
a displacement-detection module for generating a displacement detection signal in response to a displacement of the wireless mouse;
a wireless transmission module for transmitting a wireless signal;
an e-paper display module; and
a control module, electronically connected with the input operation interface, the displacement-detection module, the wireless transmission module, and the e-paper display module, for controlling the wireless mouse;
wherein the control module is configured to display a display message on the e-paper display module.

13. The wireless mouse as claimed in claim 12, wherein the display message is a mouse resolution.

14. The wireless mouse as claimed in claim 12, wherein the control module controls the wireless transmission module to wirelessly receive the display message from a computer.

15. The wireless mouse as claimed in claim 14, wherein the display message is one of an email message, a medium playing message, a gadget operating message, and a combination thereof.

16. The wireless mouse as claimed in claim 12, further comprising a temperature detection module, electronically connected with the control module, for providing a temperature message to the control module.

17. The wireless mouse as claimed in claim 16, wherein the display message is the temperature message.

18. The wireless mouse as claimed in claim 12, further comprising a timer, electronically connected with the control module, for providing a temporal message to the control module.

19. The wireless mouse as claimed in claim 18, wherein the display message is the temporal message.

20. The wireless mouse as claimed in claim 18, further comprising an optical indication module, electronically connected with the control module, wherein the control module determines one of a mouse mode and a presentation mode according to the operation signal.

21. The wireless mouse as claimed in claim 20, wherein the temporal message is one of an elapsed time and remained time of a presentation of the presentation mode.
